(19) United States
(12) Patent Application Publication
(10) Pub. No.: US 2024/0409314 A1
(43) Pub. Date: Dec. 12, 2024

(54) MANAGEMENT APPARATUS, MANAGEMENT METHOD, MANAGEMENT PROGRAM, AND COLLECTION AND DELIVERY SYSTEM

(71) Applicant: TOYOTA JIDOSHA KABUSHIKI KAISHA, Aichi-ken (JP)

(72) Inventors: Junya OTA, Tokyo-to (JP); Hirotaka KOMURA, Tokyo-to (JP); Kenta MURAMOTO, Narashino-shi (JP); Shunta SHIMIZU, Tokyo-to (JP)

(73) Assignee: TOYOTA JIDOSHA KABUSHIKI KAISHA, Aichi-ken (JP)

(21) Appl. No.: 18/732,630

(22) Filed: Jun. 4, 2024

(30) Foreign Application Priority Data
Jun. 7, 2023 (JP) 2023-093779

(51) Int. Cl. B65G 1/04; B66F 9/075; G06Q 10/08

(52) U.S. Cl. CPC B65G 1/0492; B66F 9/0755; G06Q 10/08; B65G 2203/0208

(57) ABSTRACT

A management apparatus capable of improving the collection and delivery efficiency of packages by a robot is achieved. A management apparatus includes a first identification information acquisition unit configured to acquire identification information associated with information indicating height positions of a plurality of a plurality of support parts capable of supporting a package within a collection and delivery shelf, a second identification information acquisition unit configured to acquire the identification information of a first support part that supports a collection package to be collected by the robot, a calculation unit configured to calculate a spacing between the first support part and a second support part disposed directly above the first support part, and a planning unit configured to create a collection plan for the collection package so that the robot can collect the collection package based on the information indicating the spacing.

### CROSS REFERENCE TO RELATED APPLICATIONS

This application is based upon and claims the benefit of priority from Japanese patent application No. 2023-93779, filed on Jun. 7, 2023, the disclosure of which is incorporated herein in its entirety by reference.

### BACKGROUND

The present disclosure relates to a management apparatus, a management method, a management program, and a collection and delivery system. For example, the present disclosure relates to a management apparatus, a management method, a management program, and a collection and delivery system of a collection and delivery system for collecting packages stored in a collection and delivery shelf and moving it to a collection and delivery base by a robot or delivering packages from the collection and delivery base to the collection and delivery shelf by the robot.

For example, Japanese Unexamined Patent Application Publication No. 2004-83148 discloses a mailing apparatus for specifying the vertical, horizontal, and height sizes of a package stored in a storage unit by a deliverer based on scanned images of the package, allowing the deliverer to pay a delivery fee calculated based on the size of the specified package, and for allowing a collector to retrieve the package if the collector succeeds in authentication.

### SUMMARY

The applicant has found the following problem. The technology of Japanese Unexamined Patent Application Publication No. 2004-83148 involves human collectors and is not a technology to improve the efficiency of collection of packages by robots.

The present disclosure has been made to solve such a problem, and achieves a management apparatus, a management method, a management program, and a collection and delivery system capable of improving the efficiency of collection of packages by robots.

Another aspect of the present disclosure is a management apparatus for a collection and delivery system that collects a package stored in a collection and delivery shelf and move the package to a collection and delivery base using a robot or delivers a package from the collection and delivery base to the collection and delivery shelf using the robot, the management apparatus including:
a first identification information acquisition unit configured to acquire identification information associated with information indicating height positions of a plurality of a plurality of support parts disposed in the collection and delivery shelf with adjustable height positions and capable of supporting the package;
a second identification information acquisition unit configured to acquire the identification information, from among the plurality of support parts, of a first support part that supports a collection package to be collected by the robot;
a calculation unit configured to calculate a spacing in an up-down direction of the collection and delivery shelf between the first support part and a second support part disposed directly above the first support part among the plurality of support parts; and
a planning unit configured to create a collection plan for the collection package so that the robot can collect the collection package based on the information indicating the spacing.

The above management apparatus may further include an empty height information acquisition unit configured to acquire information indicating an empty height of a storage unit for storing the package in the robot, and
the planning unit may create a collection plan for the collection package so that the robot capable of collecting the collection package collects the collection package based on the information indicating the spacing and the information indicating the empty height of the storage unit in the robot.

The above management apparatus may further include:
a first height information acquisition unit configured to acquire information indicating a height of the package based on detection information of a detection sensor mounted on the robot for detecting a state inside the collection and delivery shelf; and
a control unit configured to control the robot. The control unit may control the robot to detect the package stored in the collection and delivery shelf using the detection sensor while the robot raises the delivery package in order to store a delivery package, which is the package to be delivered by the robot, above the package stored in the collection and delivery shelf when the package is stored in the collection and delivery shelf.

The above management apparatus may further include:
a first height information acquisition unit configured to acquire information indicating a height of the package based on detection information of a detection sensor mounted on the robot for detecting a state inside the collection and delivery shelf;
a second height information acquisition unit configured to acquire information indicating a height of a delivery package to be delivered by the robot;
a reception completion information acquisition unit configured to acquire information indicating completion of receiving the delivery package input by a requester who requested the delivery of the delivery package;
a storage state information acquisition unit configured to acquire information indicating a storage state of the package within the collection and delivery shelf based on the identification information of the support part disposed in the collection and delivery shelf, information indicating the height of the delivery package, and the information indicating the completion of receiving the delivery package; and
a storage state information update unit configured to update the information indicating the storage state of the package within the collection and delivery shelf based on the detection information of the detection sensor.

In the above management apparatus, the planning unit may create a delivery plan for the delivery package so that the delivery package, along with a third support part supporting the delivery package, can be stored in the collection and delivery shelf based on the updated information indicating the storage state of the package within the collection and delivery shelf.

The above management apparatus may further comprise:
a first height information acquisition unit configured to acquire information indicating a height of the package based on detection information of a detection sensor mounted on the robot for detecting a state inside the collection and delivery shelf; and
a second height information acquisition unit configured to acquire information indicating a height of the collection package input by a requester who requested the collection of the collection package. The planning unit may create a collection plan for a next collection of the collection package by changing rates at which the information indicating the spacing when the collection package is collected relative to the information indicating the height of the collection package input by the requester is reflected based on the difference between the height of the collection package based on the detection information of the detection sensor and the height of the collection package input by the requester.

The above management apparatus may further include a control unit configured to control the robot. When a delivery package to be delivered by the robot is stored in the collection and delivery shelf, the control unit may control, if there is another support part in a region lower than the height position where the third support part for supporting the delivery package within the collection and delivery shelf is disposed, the robot to detect a state around a height position where the third support part is disposed within the collection and delivery shelf using the detection sensor mounted on the robot in order to detect the state inside the collection and delivery shelf, whereas if there is no other support part in the region lower than the height position where the third support part is disposed within the collection and delivery shelf, the detection of the state around the height position where the third support part is disposed within the collection and delivery shelf using the detection sensor is omitted.

Another aspect of the present disclosure is a collection and delivery system including:
the above management apparatus;
the robot; and
the collection and delivery shelf.

Another aspect of the present disclosure is a management method for a collection and delivery system that collects a package stored in a collection and delivery shelf and move the package to a collection and delivery base using a robot or delivers a package from the collection and delivery base to the collection and delivery shelf using the robot, the management method comprising:
acquiring identification information associated with information indicating height positions of a plurality of a plurality of support parts disposed in the collection and delivery shelf with adjustable height positions and capable of supporting the package;
acquiring the identification information, from among the plurality of support parts, of a first support part that supports a collection package to be collected by the robot;
calculating a spacing in a height direction between the first support part and a second support part disposed directly above the first support part among the plurality of support parts; and
creating a collection plan for the collection package so that the robot can collect the collection package based on the information indicating the spacing.

Another aspect of the present disclosure is a management program for a collection and delivery system that collects a package stored in a collection and delivery shelf and move the package to a collection and delivery base using a robot or delivers a package from the collection and delivery base to the collection and delivery shelf using the robot, the management program causing a computer to execute:
processing of acquiring identification information associated with information indicating height positions of a plurality of a plurality of support parts disposed in the collection and delivery shelf with adjustable height positions and capable of supporting the package;
processing of acquiring the identification information, among the plurality of support parts, of a first support part that supports a collection package to be collected by the robot;
processing of calculating a spacing in a height direction between the first support part and a second support part disposed directly above the first support part among the plurality of support parts; and
processing of creating a collection plan for the collection package so that the robot can collect the collection package based on the information indicating the spacing.

According to the present disclosure, it is possible to provide a management apparatus, a management method, a management program, and a collection and delivery system capable of improving the efficiency of collection of packages by robots.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a block diagram showing a configuration of a control system of a collection and delivery system according to a first embodiment;

FIG. 2 shows a state in which a package is delivered to a collection and delivery shelf by a robot and a package is collected from the collection and delivery shelf by the robot in the collection and delivery system according to the first embodiment;

FIG. 3 shows a state in which a tray supporting the package is supported by rails of the collection and delivery shelf;

FIG. 4 is a side view showing the robot according to the first embodiment;

FIG. 5 is a flowchart diagram showing a flow of collecting and delivering packages using the collection and delivery system according to the first embodiment;

FIG. 6 is a flowchart diagram showing a flow of processing for storing delivery packages in the collection and delivery shelf in the collection and delivery system according to the first embodiment;

FIG. 7 shows a state showing detection of packages stored on a collection and delivery shelf by a robot detection sensor in a collection and delivery system according to a second embodiment;

FIG. 8 is a flowchart diagram showing a flow of delivering packages using a collection and delivery system according to a third embodiment; and

FIG. 9 is a block diagram showing a configuration of a control system of a collection and delivery system according to a fourth embodiment.

### DESCRIPTION OF EMBODIMENTS

A specific embodiment to which the present disclosure is applied will now be described in detail with reference to the drawings. However, the present disclosure is not limited to the following embodiments. The following description and drawings are simplified as appropriate.

### First Embodiment

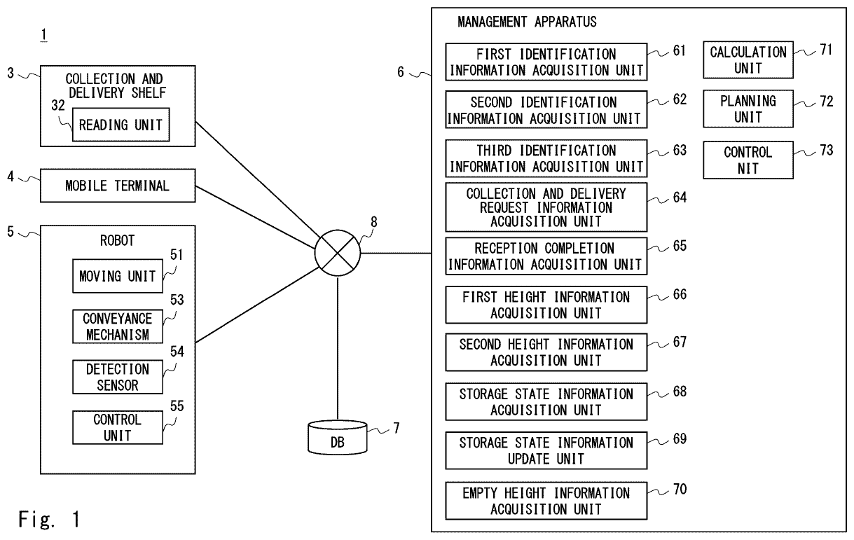

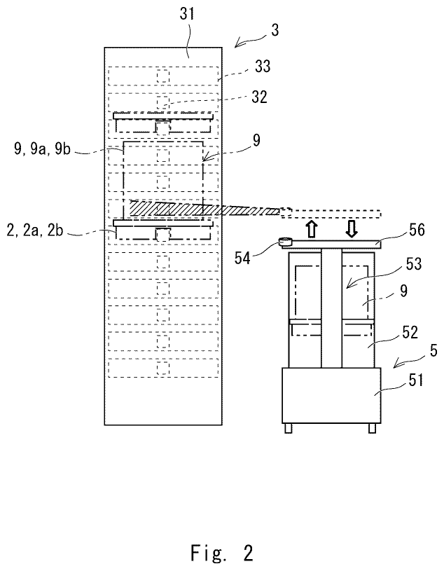

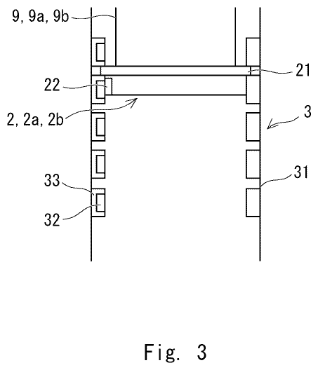

A collection and delivery system according to this embodiment is suitable for collecting packages stored in a collection and delivery shelf by a robot to a collection and delivery base or delivering packages from the collection and delivery base to the collection and delivery shelf by the robot. FIG. 1 is a block diagram showing a configuration of a control system of the collection and delivery system according to this embodiment. FIG. 2 is a diagram showing how a package is delivered to the collection and delivery shelf by a robot and a package is collected from the collection and delivery shelf by the robot in the collection and delivery system according to this embodiment. FIG. 3 shows a state in which a tray supporting the package is supported by rails of the collection and delivery shelf.

In FIG. 2, trays and packages are shown as virtual lines. Here, the “collection and delivery base” is a place where packages for delivery and collection are stored. “Collection and delivery” means to deliver or collect a package.

As shown in FIGS. 1 to 3, the collection and delivery system 1 according to this embodiment includes a tray (supporting part) 2, a collection and delivery shelf 3, a mobile terminal 4, a robot 5, a management apparatus 6, and a database (DB) 7. The collection and delivery shelf 3, the mobile terminal 4, the robot 5, the management apparatus 6, and the DB7 are connected via a network 8. The network 8 is a wired or wireless communication line, for example, the Internet.

As shown in FIGS. 2 and 3, for example, the tray 2 has a flat plate shape capable of supporting a package 9 as a basic configuration, and a flange 21 protrudes on the sides of the tray 2. A tag 22 storing identification information assigned to each tray 2 is provided on the side face of the tray 2.

The tag 22 may be, for example, an NFC (Near Field Communication) tag for which the identification information can be read by a reading apparatus. The tray 2 is repeatedly used to collect and deliver the package 9 and is collected and delivered along with the package 9.

The collection and delivery shelf 3 is disposed, for example, at the residence of a requester who requests collection and delivery of the package 9, which is a representative example of a delivery or collection location of the package 9. The collection and delivery shelf 3 includes, for example, a frame 31 and a reading unit 32 as shown in FIGS. 2 and 3. The frame 31 has, for example, a substantially rectangular frame shape when viewed from the front face of the frame 31 as a basic form, and the front and rear faces of the frame 31 are open.

As shown in FIGS. 2 and 3, a plurality of pairs of rails 33 are arranged with spacing in the up-down direction of the frame 31 on the inner face of the frame 31. The pair of rails 33 extends in the front-rear direction of the frame 31, and supports the tray 2 by the flange 21 of the tray 2 placed on the pair of rails 33.

That is, the height position at which the tray 2 is supported can be changed by appropriately selecting the pair of rails 33 from among the plurality of the pairs of rails 33. Each of the plurality of pairs of rails 33 has the identification information with which information indicating the height position of the rails 33 is associated with the corresponding pair of rails 33.

The reading unit 32 reads the identification information of the tray 2 from the tag 22 of the tray 2 while the tray 2 is supported by the pair of rails 33. Therefore, the reading unit 32 is fixed to the frame 31 for each pair of rails 33 as shown in, for example, FIGS. 2 and 3.

The reading unit 32 associates the read identification information of the tray 2 with the information indicating the height position of the rails 33 supporting the tray 2 (i.e., information indicating the height position of the tray 2 within the collection and delivery shelf 3) and transmits it to the DB7.

The mobile terminal 4 is owned by a requester who requests collection and delivery of the package 9, and accepts, for example, information indicating a collection and delivery request for the package 9 and information indicating the completion of receiving the package 9 are input by the requester. The mobile terminal 4 transmits the information indicating the collection and delivery request for the package 9 and information indicating the completion of receiving the package 9 to the DB7.

Here, the information indicating the collection and delivery request for the package 9 includes information indicating the collection and delivery request for the package 9 and information indicating the request for delivery of the package 9. When the requester requests collection of the package 9, the identification information of the tray 2 supporting the package 9 is read through the mobile terminal 4 when the requester stores the package 9 in the collection and delivery shelf 3, and the mobile terminal 4 associates the identification information with the information indicating the request to collect the package 9 and transmits the associated information to the DB7.

The robot 5 is a mobile body for collecting and delivering the package 9, along with the tray 2, between the collection and delivery base and the collection and delivery shelf 3. In the collection and delivery system 1 according to this embodiment, a plurality of robots 5 are operating, and each robot 5 has identification information.

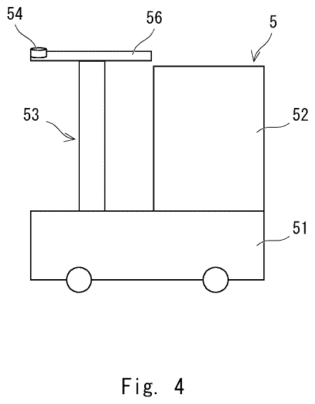

FIG. 4 is a side view showing a robot according to this embodiment. For example, as shown in FIGS. 1 and 4, the robot 5 includes a moving unit 51, a storage unit 52, a conveyance mechanism 53, a detection sensor 54, and a control unit 55. The moving unit 51 is a base that moves by a driving source such as a motor.

The storage unit 52 is, for example, a box capable of storing the package 9 and the tray 2, and is fixed to the moving unit 51 as shown in FIG. 4. The conveyance mechanism 53 can raise a top plate 56 in the up-down direction of the robot 5, and the package 9, along with the tray 2, can be retrieved from the storage unit 52 to the top plate 56 and stored in the collection and delivery shelf 3, or retrieved from the collection and delivery shelf 3 to the top plate 56 and stored in the storage unit 52.

The detection sensor 54 is provided on the top plate 56 of the robot 5 for detecting a state inside the collection and delivery shelf 3. The detection sensor 54 can be composed of a scan sensor such as Lidar. By using the reflection light from the package 9 acquired as the top plate 56 moves in the up-down direction of the robot 5, the detection sensor 54 detects the packages 9 and measures its height. The detection sensor 54 transmits, to the DB7, information indicating the height of the package 9 including information indicating the height position where the package 9 is disposed. The control unit 55 controls the moving unit 51 and the conveyance mechanism 53.

The management apparatus 6 manages the collection and delivery of the package 9. As shown in FIG. 1, the management apparatus 6 includes a first identification information acquisition unit 61, a second identification information acquisition unit 62, a third identification information acquisition unit 63, a collection and delivery request information acquisition unit 64, a reception completion information acquisition unit 65, a first height information acquisition unit 66, a second height information acquisition unit 67, a storage state information acquisition unit 68, a storage state information update unit 69, an empty height information acquisition unit 70, a calculation unit 71, a planning unit 72, and a control unit 73.

The first identification information acquisition unit 61 acquires identification information of the tray 2 with which information indicating the height position of the tray 2 in the collection and delivery shelf 3 is associated. Thus, the management apparatus 6 can always recognize which tray 2 is supported by which rails 33 within the collection and delivery shelf 3.

The second identification information acquisition unit 62 acquires the identification information of a collection tray 2a with which the information indicating the height position of the collection tray 2a supporting the package 9 to be collected is associated among the trays 2 within the collection and delivery shelf 3.

The third identification information acquisition unit 63 acquires the identification information of a delivery tray 2b with which the information indicating the height position of the delivery tray 2b supporting the package 9 to be delivered is associated among the trays 2 within the collection and delivery shelf 3. In the following description, in order to clarify the explanation, a package to be collected is referred to as a collection package 9a, a package to be delivered is referred to as a delivery package 9b, and both of them are collectively referred to as the package 9.

The collection and delivery request information acquisition unit 64 acquires information indicating the collection and delivery request for the package 9 input by the requester. The reception completion information acquisition unit 65 acquires information indicating the reception completion of the delivery package 9b input by the requester when he/she has received the delivery package 9b. The first height information acquisition unit 66 acquires information indicating the height of the package 9, including information indicating the height position where the package 9 is disposed, detected by the detection sensor 54 mounted on the robot 5.

The second height information acquisition unit 67 acquires height information of the delivery package 9b. Here, information indicating the height of the delivery package 9b can be input, for example, by an operator using an input apparatus at the collection and delivery base. However, the method of acquiring information indicating the height of the delivery package 9b is not limited.

The storage state information acquisition unit 68 creates and acquires information indicating the storage state of the package 9 within the collection and delivery shelf 3 based on the identification information of the tray 2 including the collection tray 2a and the delivery tray 2b within the collection and delivery shelf 3, the information indicating the height of the delivery package 9b, and the information indicating the completion of receiving the delivery package 9b.

At this time, the storage state information acquisition unit 68 may create the information indicating the storage state of the package 9 within the collection and delivery shelf 3 based on the identification information of the collection tray 2a supporting the collection package 9a associated with the information indicating the collection and delivery request for the package 9, assuming that the collection package 9a is present between the collection tray 2a and the tray 2 disposed directly above the collection tray 2a. The storage state information acquisition unit 68 transmits, to the DB7, the information indicating the storage state of the package 9 within the collection and delivery shelf 3.

The storage state information update unit 69 updates the information indicating the storage state of the package 9 within the collection and delivery shelf 3 based on the information indicating the height of the package 9, including the height position where the package 9 is disposed, detected by the detection sensor 54 mounted on the robot 5.

That is, the information indicating the storage state of the package 9 within the collection and delivery shelf 3 is updated when the requester has stored the collection package 9a in the collection and delivery shelf 3 but has forgotten to input information indicating the request to collect the collection package 9a, or when the requester has received the delivery package 9b but has forgotten to input information indicating the completion of the receipt. The storage state information update unit 69 transmits, to the DB 70, the updated information indicating the storage state of the package 9 in the collection and delivery shelf 3 to the DB7.

The empty height information acquisition unit 70 acquires information indicating the empty height of the storage unit 52 for each robot 5. Based on information indicating the height position of the tray 2 within the collection and delivery shelf 3 associated with the identification information of the tray 2, the calculation unit 71 calculates the spacing between the trays 2 arranged adjacent in the up-down direction within the collection and delivery shelf 3.

At this time, the calculation unit 71 calculates the spacing in the up-down direction between the collection tray 2a supporting the collection package 9a and the tray 2 disposed directly above the collection tray 2a within the collection and delivery shelf 3. The calculation unit 71 transmits information indicating the spacing between the trays 2 to the DB7.

The planning unit 72 creates a collection and delivery plan for the package 9. At this time, the planning unit 72 selects the robot 5 capable of collecting the collection package 9a, along with the collection tray 2a, based on the identification information of the trays 2 including the collection tray 2a within the collection and delivery shelf 3, from which the package will be collected (such a shelf shall be hereinafter referred to as a collection destination shelf), the information indicating the spacing between the trays 2 within the collection and delivery shelf 3 (the collection destination shelf), the identification information of the robot 5, and the information indicating the empty height of the storage unit 52 for each robot 5, and creates the collection plan so that the selected robot 5 collects the collection package 9a, or reserves the selected robot 5.

The planning unit 72 selects the rails 33 capable of storing the delivery package 9b, along with the delivery tray 2b, in the collection and delivery shelf 3 based on the information indicating the storage state of the package 9 within the collection and delivery shelf 3, to which the package will be delivered (such a shelf shall be hereinafter referred to as a delivery destination shelf), identification information of the rails 33 of the collection and delivery shelf 3 of the delivery destination, the identification information of the tray 2 within the collection and delivery shelf 3 (the delivery destination shelf), and information indicating the height of the delivery package 9b, and creates a delivery plan so that the delivery tray 2b, along with the delivery package 9b, is supported by the selected rails 33, or reserves the selected rails 33.

At this time, based on map information, information indicating the location of the collection and delivery base, and information indicating the address included in the personal information of the requester, the planning unit 72 creates travel routes for the outbound and the inbound routes of the robot 5 as it moves between the collection and delivery base and the collection and delivery shelf 3. The planning unit 72 includes the information about the travel routes of the robot 5 in the information indicating the collection and delivery plan for the package 9 and transmits it to the DB 7.

The planning unit 72 transmits the identification information of the selected robot 5 and the identification information of the selected rails 33 to the DB7. Here, the planning unit 72 may update the information indicating the empty height of the storage unit 52 for each robot 5 every time it creates a collection and delivery plan for the package 9. Based on the information indicating the collection and delivery plan for the package 9, the control unit 73 controls the robot 5 to collect and deliver the package 9.

The DB7 stores the identification information of the tray 2 including the collection tray 2a and the delivery tray 2b in the collection and delivery shelf 3, the identification information of the rails 33 of the collection and delivery shelf 3, the identification information of the selected rails 33 of the collection and delivery shelf 3, the information indicating the spacing between the trays 2 in the collection and delivery shelf 3, the information indicating the height of the delivery package 9b, and the information indicating the collection and delivery request for the package 9.

The DB7 stores information indicating the completion of receiving the delivery package 9b, the identification information of the robot 5, the identification information of the selected robot 5, the information indicating the height of the package 9 stored in the collection and delivery shelf 3 detected by the detection sensor 54 of the robot 5, the information indicating the empty height of the robot 5, the information indicating the storage state of the package 9 within the collection and delivery shelf 3, the information indicating the collection and delivery plan for the package 9, the map information, and the personal information of the requester.

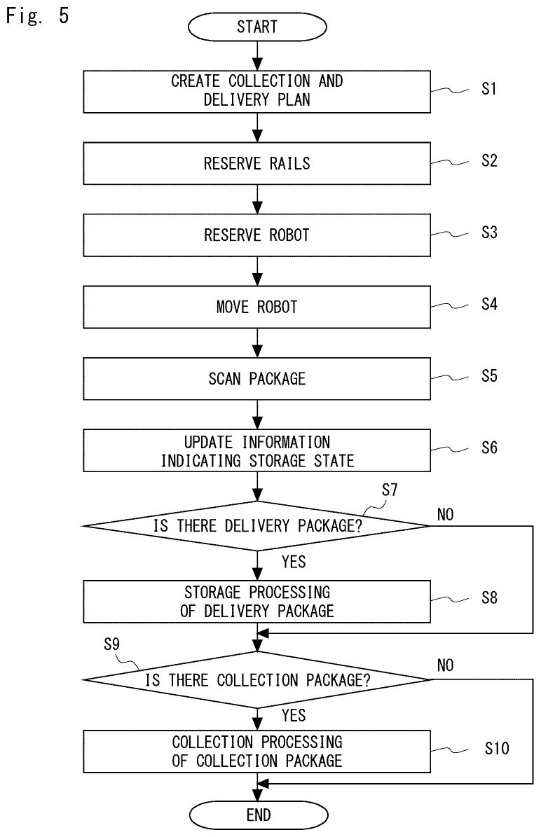

Next, a flow of collecting and delivering packages 9 using the collection and delivery system 1 according to this embodiment will be described. FIG. 5 is a flowchart diagram showing a flow of collecting and delivering packages using the collection and delivery system according to this embodiment.

Here, it is assumed that the requester inputs information indicating the collection and delivery request for the package 9, and the storage state information acquisition unit 68 of the management apparatus 6 creates the information indicating the storage state of the package 9 within the collection and delivery shelf 3. First, the planning unit 72 of the management apparatus 6 creates a collection and delivery plan for the package 9, creates a travel route of the robot 5, includes information indicating the travel route of the robot 5 in information indicating the collection and delivery plan for the package 9, and transmits the information to the DB7 (S1).

Specifically, when delivering the delivery package 9b, the planning unit 72 of the management apparatus 6 selects the rails 33 of the collection and delivery shelf 3 capable of storing the delivery package 9b, along with the delivery tray 2b, based on the identification information of the rails 33 of the collection and delivery shelf 3 (the delivery destination shelf), the information indicating the storage state of the package 9 in the collection and delivery shelf 3 (the delivery destination shelf), the identification information of the tray 2 within the collection and delivery shelf 3 (the delivery destination shelf) and the information indicating the height of the delivery package 9b acquired from the DB7, and creates a delivery plan so that the delivery tray 2b, along with the delivery package 9b, is supported on the selected rails 33.

That is, the planning unit 72 of the management apparatus 6 selects the rails 33 for supporting the delivery tray 2b, along with the delivery package 9b, so that the delivery package 9b is stored in an area within the spacing of the tray 2 in the collection and delivery shelf 3, which is the delivery destination shelf where the package 9 is not stored.

On the other hand, when collecting the collection package 9a, the planning unit 72 of the management apparatus 6 selects a robot 5 capable of collecting the collection package 9a, along with the collection tray 2a, based on the identification information of the tray 2 within the collection and delivery shelf 3 (the delivery destination shelf), the information indicating the spacing of the tray 2 within the collection and delivery shelf 3 (the collection destination shelf), the identification information of the robot 5, and the information indicating the empty height of the robot 5 obtained from the DB7, and creates a collection plan so that the selected robot 5 collects the collection package 9a.

That is, the planning unit 72 of the management apparatus 6 selects, from among the plurality of robots 5, a robot 5 which has a higher empty height in the storage unit 52 compared to the spacing between the collection tray 2a and the tray 2 disposed directly above the collection tray 2a. At this point, the empty height of the storage unit 52 should be sufficient, for example, to accommodate at least the height of the collection tray 2a added to the spacing.

At this time, based on the map information, the information indicating the location of the collection and delivery base, and information indicating the address included in the personal information of the requester, the planning unit 72 of the management apparatus 6 creates travel routes for the outbound and the inbound routes of the robot 5 as it moves between the collection and delivery base and the collection and delivery shelf 3. The planning unit 72 includes the information about the travel routes of the robot 5 in the information indicating the collection and delivery plan for the package 9 and transmits it to the DB 7.

Next, when the delivery package 9b is delivered, the planning unit 72 of the management apparatus 6 transmits, to the DB7, the identification information of the selected rails 33 to reserve the rails 33 (S2). When the collection package 9a is collected, the planning unit 72 transmits, to the DB7, the identification information of the selected robot 5 to reserve the robot 5 (S3).

Next, based on the information indicating the travel route of the robot 5 included in the information indicating the collection and delivery plan for the package 9, the control unit 73 of the management apparatus 6 controls the moving unit 51 through the control unit 55 of the robot 5 to cause the robot 5 to arrive at the collection and delivery shelf 3 (S4). At this point, when delivering the delivery package 9b, the robot 5 delivers the delivery package 9b, along with the delivery tray 2b, while the delivery package 9b is stored in the storage unit 52 of the robot 5.

Next, the control unit 73 of the management apparatus 6 controls the conveyance mechanism 53 through the control unit 55 of the robot 5 to raise the top plate 56, and control the detection sensor 54 to detect the package 9 in the collection and delivery shelf 3 (S5). In other words, the package 9 is scanned from the lower side to the upper side of the collection and delivery shelf 3 by the detection sensor 54. The robot 5 transmits, to the DB 7, information indicating the height of the package 9 including information indicating the height position where the detected package 9 is disposed.

Next, the storage state information update unit 69 of the management apparatus 6 updates the information indicating the storage state of the package 9 in the collection and delivery shelf 3 based on the information indicating the height of the package 9, including the information indicating the height position where the package 9 is disposed, detected by the detection sensor 54 of the robot 5 which has been acquired from the DB7 (S6).

Thus, for example, the information indicating the storage state of the package 9 within the collection and delivery shelf 3 is accurately understood when the requester has stored the collection package 9a in the collection and delivery shelf 3 but has forgotten to input information indicating the request to collect the collection package 9a, or when the requester has received the delivery package 9b but has forgotten to input information indicating the completion of the receipt. The storage state information update unit 69 transmits, to the DB 70, the updated information indicating the storage state of the package 9 in the collection and delivery shelf 3 to the DB7.

Next, the control unit 73 of the management apparatus 6 determines whether or not there is the delivery package 9b (S7). That is, the control unit 73 determines whether or not there is a delivery of the delivery package 9b in the requester's request. If there is a delivery of the delivery package 9b in the requester's request (YES in S7), processing for storing the delivery package 9b in the collection and delivery shelf 3 is executed (S8).

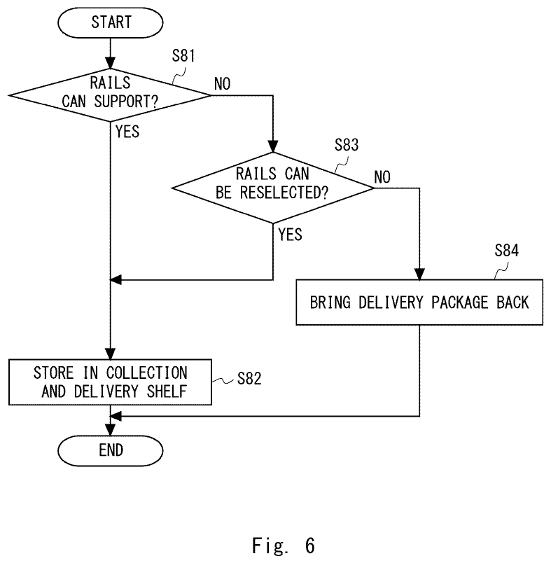

FIG. 6 is a flowchart diagram showing a flow of the storage processing of the delivery package in the collection and delivery shelf in the collection and delivery system according to this embodiment. First, the planning unit 72 of the management apparatus 6 determines whether it is possible to make the selected rails 33 support the delivery tray 2b, along with the delivery package 9b, based on the updated information indicating the storage state of the package 9 in the collection and delivery shelf 3 (the delivery destination shelf), the identification information of the rails 33 of the collection and delivery shelf 3 (the delivery destination shelf), the identification information of the tray 2 in the collection and delivery shelf 3 (the delivery destination shelf), and the identification information of the selected rails 33 acquired from the DB7 (S81).

If the selected rails 33 can support the delivery tray 2b, along with the delivery package 9b (YES in S81), the control unit 73 of the management apparatus 6 controls the conveyance mechanism 53 through the control unit 55 of the robot 5 based on the information indicating the height position of the rails 33 associated with the identification information of the selected rails 33, and causes the conveyance mechanism 53 to retrieve the delivery tray 2b, along with the delivery package 9b, from the storage unit 52 of the robot 5 to the top plate 56.

The control unit 73 of the management apparatus 6 controls the conveyance mechanism 53 through the control unit 55 of the robot 5, raises the top plate 56, and causes the delivery package 9b and the delivery tray 2b to be stored in the collection and delivery shelf 3 so that the delivery tray 2b is supported by the selected rails 33 of the collection and delivery shelf 3 from the top plate 56 (S82).

On the other hand, when it is impossible to support the delivery tray 2b, along with the delivery package 9b, on the selected rails 33 (NO in S81), the planning unit 72 of the management apparatus 6 determines, based on the updated information indicating the storage state of the package 9 in the collection and delivery shelf 3 (delivery destination shelf), the identification information of the rails 33 within the collection and delivery shelf 3 (delivery destination shelf), the identification information of the tray 2 in the collection and delivery shelf 3 (delivery destination shelf), and the information indicating the height of the delivery package 9b obtained from the DB7, whether it is possible to once again select the rails 33 of the collection and delivery shelf 3 where the delivery package 9b can be stored, along with the delivery tray 2b (S83). In other words, the planning unit 72 determines whether or not the delivery plan for the delivery package 9b can be created again.

If it is possible to reselect the rails 33 of the collection and delivery shelf 3 (YES in S83), the planning unit 72 of the management apparatus 6 transmits the identification information of the selected rails 33 to the DB7. Then, the control unit 73 transitions to the processing in S82. On the other hand, if it is not possible to reselect the rails 33 of the collection and delivery shelf 3 (NO in S83), the control unit 73 gives up the delivery of the delivery package 9b, and controls the robot 5 to bring the delivery package 9b back to the collection and delivery base (S84).

Referring back to FIG. 5, if there is no delivery package 9b (NO in S7), or after the delivery of the delivery package 9b is completed, the control unit 73 of the management apparatus 6 determines whether there is the collection package 9a (S9). That is, the control unit 73 determines whether there is a collection of the collection package 9a in the requester's request. When the requester's request includes the collection of the collection package 9a (YES in S9), the processing for collecting the collection package 9a is executed from the collection and delivery shelf 3 (S10).

In other words, the control unit 73 of the management apparatus 6 controls the conveyance mechanism 53 through the control unit 55 of the selected robot 5 based on the information indicating the height position of the collection tray 2a associated with the identification information of the collection tray 2a acquired from the DB7, causes the conveyance mechanism 53 to retrieve the collection tray 2a, along with the collection package 9a from the collection and delivery shelf 3 to the top plate 56, and controls the top plate 56 to descend to store the collection package 9a, along with the collection tray 2a from the top plate 56 to the storage unit 52.

At this time, since the collection package 9a is always stored between the collection tray 2a and the tray 2 disposed directly above the collection tray 2a in the collection and delivery shelf 3, if there is a sufficiently large empty height in the storage unit 52 of the robot 5 compared to the spacing between the collection tray 2a and the tray 2 positioned directly above it, the robot 5 can reliably store the collection tray 2a, along with the collection package 9a, in the storage unit 52.

After that, the control unit 73 of the management apparatus 6 controls the moving unit 51 through the control unit 55 of the robot 5 based on the information indicating the travel route of the robot 5 included in the information indicating the collection and delivery plan for the package 9, and returns the robot 5 to the collection and delivery base. Thus, the collection and delivery processing of the package 9 is completed.

In this way, when collecting the collection package 9a, the collection and delivery system 1, the management apparatus 6, and the management method according to this embodiment select a robot 5 having a high empty height in the storage unit 52 compared to the spacing between the collection tray 2a and the tray 2 disposed directly above the collection tray 2a.

At this time, since the collection package 9a is always stored between the collection tray 2a and the tray 2 disposed directly above the collection tray 2a in the collection and delivery shelf 3, if there is a sufficiently large empty height in the storage unit 52 of the robot 5 compared to the spacing between the collection tray 2a and the tray 2 positioned directly above it, the robot 5 can reliably store the collection tray 2a, along with the collection package 9a, in the storage unit 52. Therefore, for example, it is possible to suppress the robot 5 from returning to the collection and delivery base without collecting the collection package 9a at the collection destination shelf, thereby improving the collection and delivery efficiency of the package 9 by the robot 5.

Moreover, the collection and delivery system 1, the management apparatus 6, and the management method according to this embodiment update the information indicating the storage state of the package 9 in the collection and delivery shelf 3 based on the detection result of the detection sensor 54 of the robot 5. Therefore, for example, even when the requester has stored the collection package 9a in the collection and delivery shelf 3 but has forgotten to input information indicating the request to collect the collection package 9a, the robot 5 can suppress attempts to store the delivery package 9b in the area where the collected items 9a are stored within the collection and delivery shelf 3.

In the above embodiment, although the storage state information acquisition unit 68 of the management apparatus 6 acquires the information indicating the storage state of the package 9 in the collection and delivery shelf 3, and the storage state information update unit 69 updates the information indicating the storage state of the package 9 in the collection and delivery shelf 3 based on the detection information of the detection sensor 54 of the robot 5, the storage state information acquisition unit 68 of the management apparatus 6, the storage state information update unit 69, and the detection sensor 54 of the robot 5 may be omitted.

Further, the steps S2 and S3 in the above embodiment may be in reverse order, and the steps S7 and S8 and the steps S9 and S10 may be in reverse order. Furthermore, although the flow of collecting and delivering the package 9 is described in the above embodiment, the process of collecting the collection package 9a and the process of delivering the delivery package 9b may be different.

### Second Embodiment

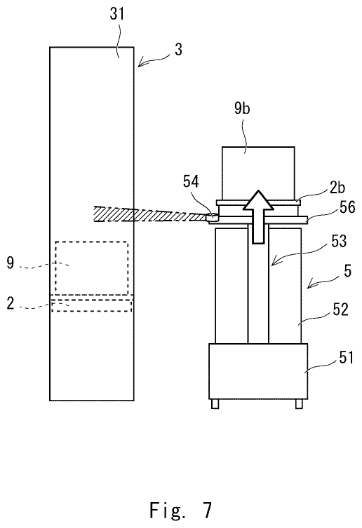

FIG. 7 shows a state in which a package stored in a collection and delivery shelf is detected by a detection sensor of a robot in the collection and delivery system according to this embodiment. FIG. 7 shows a simplified view, and the reading unit 32 and the rails 33 are omitted. In this embodiment, the detection sensor 54 of the robot 5 improves the efficiency when detecting the package 9 in the collection and delivery shelf 3.

In detail, for example, when the delivery package 9b is stored in the collection and delivery shelf 3 above the package 9 stored in the collection and delivery shelf 3, the control unit 73 of the management apparatus 6 controls the conveyance mechanism 53 through the control unit 55 of the robot 5 so that the detection sensor 54 detects the package 9 stored in the collection and delivery shelf 3 while the robot 5 raises the delivery package 9b, as shown in FIG. 7 while the package 9 is stored in the collection and delivery shelf 3.

As a result, it becomes possible to simultaneously detect the package 9 stored in the collection and delivery shelf 3 with the rise of the delivery package 9b. This improves the efficiency of the detection sensor 54 of the robot 5 in detecting the package 9 in the collection and delivery shelf 3. At this point, the delivery plan for the delivery package 9b may be created so that the delivery package 9b is disposed above the package 9 stored in the collection and delivery shelf 3.

### Third Embodiment

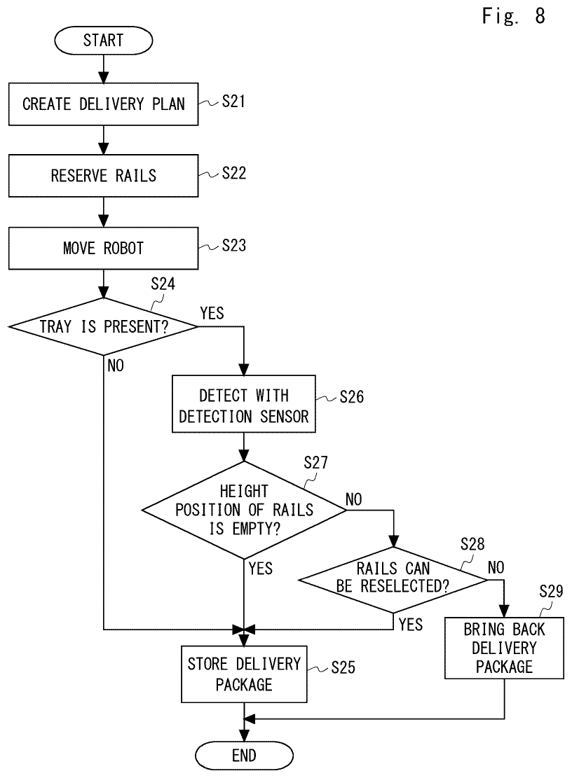

FIG. 8 is a flowchart diagram showing a flow of delivering packages using the collection and delivery system according to this embodiment. In this embodiment, the detection sensor 54 of the robot 5 also improves efficiency in detecting the packages 9 in the collection and delivery shelf 3.

In detail, in this embodiment, the flow until the management apparatus 6 creates a delivery plan for the delivery package 9b (S21), reserves the rails 33 for supporting the delivery tray 2b, along with the delivery package 9b, in the collection and delivery shelf 3 (S22), and moves the robot 5 to the collection and delivery shelf 3 (S23) is the same as that according to the first embodiment.

Next, the control unit 73 of the management apparatus 6 determines whether or not the tray 2 is present in the lower region of the reserved rails 33 in the collection and delivery shelf 3 based on the identification information of the tray 2 in the collection and delivery shelf 3 (the delivery destination shelf), the identification information of the rails 33 within the collection and delivery shelf 3 of the delivery destination, and the identification information of the reserved rails 33 (S24).

When there is no tray 2 in the lower region of the reserved rails 33 (NO in S24), the control unit 73 of the management apparatus 6 omits the detection of the package 9 within the collection and delivery shelf 3 by the detection sensor 54 of the robot 5, controls the conveyance mechanism 53 through the control unit 55 of the robot 5 based on the information indicating the height position of the rails 33 associated with the identification information of the selected rails 33, and causes the conveyance mechanism 53 to store the delivery package 9b in the collection and delivery shelf 3 so that the delivery tray 2b, along with the delivery package 9b, is supported by the reserved rails 33 (S25).

In other words, when there is no tray 2 in the lower region of the reserved rails 33, it is obvious that there is no package 9 in the lower region of the reserved rails 33, and it is also obvious that the delivery package 9b can be stored in the collection and delivery shelf 3. Therefore, it is possible to omit the detection of the package 9 in the collection and delivery shelf 3 performed by the detection sensor 54 of the robot 5, improving the efficiency when the detection sensor 54 of the robot 5 detects the package 9 in the collection and delivery shelf 3.

On the other hand, when the tray 2 is present in the lower region of the reserved rails 33 (YES in S24), the control unit 73 of the management apparatus 6 controls the conveyance mechanism 53 through the control unit 55 of the robot 5, and causes the detection sensor 54 to detect the state of the reserved rails 33 around the height position in the collection and delivery shelf 3 (S26).

Then, the control unit 73 of the management apparatus 6 determines whether the tray 2 or the package 9 is not present around the height position of the reserved rails 33 in the collection and delivery shelf 3, that is, whether the height position of the reserved rails 33 is empty (S27). When the height position of the reserved rails 33 is empty (YES in S27), the control unit 73 transitions to the processing in S25.

On the other hand, when the height position of the reserved rails 33 is not empty (NO in S27), the planning unit 72 of the management apparatus 6 determines, based on the information indicating the storage state of the package 9 within the collection and delivery shelf 3 (delivery destination shelf), the identification information of the rails 33 in the collection and delivery shelf 3 (delivery destination shelf), the identification information of the tray 2 within the collection and delivery shelf 3 (delivery destination shelf), and the information indicating the height of the delivery package 9b acquired from the DB7, whether it is possible to once again select the rails 33 of the collection and delivery shelf 3 where the delivery package 9b can be stored along with the delivery tray 2b (S28). In other words, the planning unit 72 determines whether or not the delivery plan for the delivery package 9b can be created again.

If it is possible to reselect the rails 33 of the collection and delivery shelf 3 (YES in S28), the planning unit 72 of the management apparatus 6 transmits the identification information of the selected rails 33 to the DB7. Then, the control unit 73 transitions to the processing in S25. On the other hand, if it is not possible to reselect the rails 33 of the collection and delivery shelf 3 (NO in S28), the control unit 73 gives up the delivery of the delivery package 9b, and controls the robot 5 to bring the delivery package 9b back to the collection and delivery base (S29).

As described above, when there is no tray 2 in the lower region of the reserved rails 33, it is obvious that there is no package 9 in the lower region of the reserved rails 33, and it is also obvious that the delivery package 9b can be stored in the collection and delivery shelf 3.

Therefore, the detection of the package 9 in the collection and delivery shelf 3 by the detection sensor 54 of the robot 5 is omitted, and thus it is possible to improve the efficiency when the detection sensor 54 of the robot 5 detects the package 9 in the collection and delivery shelf 3. Note that in this embodiment, the storage state information update unit 69 according to the first embodiment may be omitted.

### Fourth Embodiment

In the first embodiment, when collecting the collection package 9a, a robot 5 having a high empty height in the storage unit 52 compared to the spacing between the collection tray 2a and the tray 2 disposed directly above the collection tray 2a is selected.

At this time, when the height of the collection package 9a is low compared to the spacing between the collection tray 2a and the tray 2 disposed directly above the collection tray 2a, an unnecessary empty height is generated in the storage unit 52 of the robot 5. Therefore, in this embodiment, an unnecessary empty height of the storage unit 52 of the robot 5 is reduced.

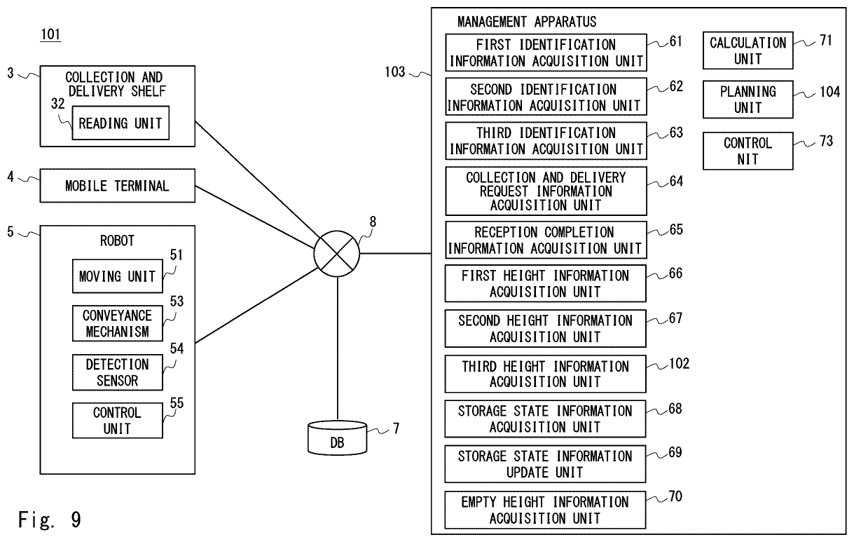

FIG. 9 is a block diagram showing a configuration of a control system of the collection and delivery system according to this embodiment. As shown in FIG. 9, a collection and delivery system 101 according to this embodiment includes a third height information acquisition unit 102 for acquiring information indicating the height of the collection package 9a input by a requester requesting collection of the collection package 9a through the mobile terminal 4. Since the collection and delivery system 101 according to this embodiment has a configuration substantially equal to that of the collection and delivery system 1 according to the first embodiment, elements equal to those according to the first embodiment and the like will be described by using the same signs.

Here, the information indicating the height of the collection package 9a input by the requester via the mobile terminal 4 may be inaccurate, and if the robot 5 is selected based only on the information indicating the height of the collection package 9a input by the requester through the mobile terminal 4, the collection package 9a may not be collected by the robot 5.

Therefore, the planning unit 104 of the management apparatus 103 according to this embodiment creates a collection plan for a next collection of the collection package 9a by changing rates (i.e., degrees reliability) at which the information indicating the spacing between the collection tray 2a and the tray 2 disposed directly above the collection tray 2a when the collection package 9a is collected relative to the information indicating the height of the collection package 9a input by the requester is reflected based on the difference between the height of the collection package 9a based on the detection information of the detection sensor 54 of the robot 5 and the height of the collection package 9a input by the requester.

The rate to be reflected can be calculated based on, for example, the proportion of the difference between the height of the collection package 9a based on the detection information of the detection sensor 54 of the robot 5 and the height of the collection package 9a input by the requester relative to the height of the collection package 9a based on the detection information of the detection sensor 54 of the robot 5, and the number of times the requester has requested the collection of the collection package 9a.

By changing the rate at which the information indicating the height of the collection package 9a input by the requester is reflected when creating the collection plan for the collection package 9a in this way, it is possible to reduce the unnecessary empty height of the storage unit 52 of the robot 5 while suppressing the inability of the robot 5 to collect the collection package 9a.

### OTHER EMBODIMENTS

In the above embodiments, the package 9 is supported by the tray 2, and instead the package 9 may be supported by storing the package 9 in a storing box or the like. In the above embodiments, the tray 2 is supported by a plurality of pairs of rails 33 so that the height position of the tray 2 can be changed within the collection and delivery shelf 3. However, the support part for supporting the package 9 may be supported so that the height position of the tray 9 can be changed in the collection and delivery shelf 3.

Some or all of the above processing may be executed by a computer program. That is, by having a control computer constituting the processing apparatus executes the program, the control of the processing apparatus can be executed. The above program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A management apparatus for a collection and delivery system that collects a package stored in a collection and delivery shelf and move the package to a collection and delivery base using a robot or delivers a package from the collection and delivery base to the collection and delivery shelf using the robot, the management apparatus comprising:
a first identification information acquisition unit configured to acquire identification information associated with information indicating height positions of a plurality of a plurality of support parts disposed in the collection and delivery shelf with adjustable height positions and capable of supporting the package;
a second identification information acquisition unit configured to acquire the identification information, from among the plurality of support parts, of a first support part that supports a collection package to be collected by the robot;
a calculation unit configured to calculate a spacing in an up-down direction of the collection and delivery shelf between the first support part and a second support part disposed directly above the first support part among the plurality of support parts; and
a planning unit configured to create a collection plan for the collection package so that the robot can collect the collection package based on the information indicating the spacing.

2. The management apparatus according to claim 1, further comprising an empty height information acquisition unit configured to acquire information indicating an empty height of a storage unit for storing the package in the robot, wherein the planning unit creates a collection plan for the collection package so that the robot capable of collecting the collection package collects the collection package based on the information indicating the spacing and the information indicating the empty height of the storage unit in the robot.

3. The management apparatus according to claim 1, further comprising:
a first height information acquisition unit configured to acquire information indicating a height of the package based on detection information of a detection sensor mounted on the robot for detecting a state inside the collection and delivery shelf; and
a control unit configured to control the robot, wherein the control unit controls the robot to detect the package stored in the collection and delivery shelf using the detection sensor while the robot raises the delivery package in order to store a delivery package, which is the package to be delivered by the robot, above the package stored in the collection and delivery shelf when the package is stored in the collection and delivery shelf.

4. The management apparatus according to claim 1, further comprising:
a first height information acquisition unit configured to acquire information indicating a height of the package based on detection information of a detection sensor mounted on the robot for detecting a state inside the collection and delivery shelf;
a second height information acquisition unit configured to acquire information indicating a height of a delivery package to be delivered by the robot;
a reception completion information acquisition unit configured to acquire information indicating completion of receiving the delivery package input by a requester who requested the delivery of the delivery package;
a storage state information acquisition unit configured to acquire information indicating a storage state of the package within the collection and delivery shelf based on the identification information of the support part disposed in the collection and delivery shelf, information indicating the height of the delivery package, and the information indicating the completion of receiving the delivery package; and
a storage state information update unit configured to update the information indicating the storage state of the package within the collection and delivery shelf based on the detection information of the detection sensor.

5. The management apparatus according to claim 4, wherein the planning unit creates a delivery plan for the delivery package so that the delivery package, along with a third support part supporting the delivery package, can be stored in the collection and delivery shelf based on the updated information indicating the storage state of the package within the collection and delivery shelf.

6. The management apparatus according to claim 1, further comprising:
a first height information acquisition unit configured to acquire information indicating a height of the package based on detection information of a detection sensor mounted on the robot for detecting a state inside the collection and delivery shelf; and
a second height information acquisition unit configured to acquire information indicating a height of the collection package input by a requester who requested the collection of the collection package, wherein the planning unit creates a collection plan for a next collection of the collection package by changing rates at which the information indicating the spacing when the collection package is collected relative to the information indicating the height of the collection package input by the requester is reflected based on the difference between the height of the collection package based on the detection information of the detection sensor and the height of the collection package input by the requester.

7. The management apparatus according to claim 1, further comprising a control unit configured to control the robot, wherein, when a delivery package to be delivered by the robot is stored in the collection and delivery shelf, the control unit controls, if there is another support part in a region lower than the height position where the third support part for supporting the delivery package within the collection and delivery shelf is disposed, the robot to detect a state around a height position where the third support part is disposed within the collection and delivery shelf using the detection sensor mounted on the robot in order to detect the state inside the collection and delivery shelf, whereas if there is no other support part in the region lower than the height position where the third support part is disposed within the collection and delivery shelf, the control unit omits the detection of the state around the height position where the third support part is disposed within the collection and delivery shelf using the detection sensor.

8. A collection and delivery system comprising:
the management apparatus according to claim 1;
the robot; and
the collection and delivery shelf.

9. A management method for a collection and delivery system that collects a package stored in a collection and delivery shelf and move the package to a collection and delivery base using a robot or delivers a package from the collection and delivery base to the collection and delivery shelf using the robot, the management method comprising:
acquiring identification information associated with information indicating height positions of a plurality of a plurality of support parts disposed in the collection and delivery shelf with adjustable height positions and capable of supporting the package;
acquiring the identification information, from among the plurality of support parts, of a first support part that supports a collection package to be collected by the robot;
calculating a spacing in an up-down direction of the collection and delivery shelf between the first support part and a second support part disposed directly above the first support part among the plurality of support parts; and
creating a collection plan for the collection package so that the robot can collect the collection package based on the information indicating the spacing.

10. A non-transitory computer readable medium storing a management program for a collection and delivery system that collects a package stored in a collection and delivery shelf and move the package to a collection and delivery base using a robot or delivers a package from the collection and delivery base to the collection and delivery shelf using the robot, the management program causing a computer to execute:
processing of acquiring identification information associated with information indicating height positions of a plurality of a plurality of support parts disposed in the collection and delivery shelf with adjustable height positions and capable of supporting the package;
processing of acquiring the identification information, from among the plurality of support parts, of a first support part that supports a collection package to be collected by the robot;
processing of calculating a spacing in an up-down direction of the collection and delivery shelf between the first support part and a second support part disposed directly above the first support part among the plurality of support parts; and
processing of creating a collection plan for the collection package so that the robot can collect the collection package based on the information indicating the spacing.
